(19) United States
(12) Patent Application Publication
(10) Pub. No.: US 2016/0157001 A1
(43) Pub. Date: Jun. 2, 2016

(54) Wireless Speaker Enclsoure

(71) Applicant: Christopher Manouel, Garland, TX (US)

(72) Inventor: Christopher Manouel, Garland, TX (US)

(21) Appl. No.: 14/952,851

(22) Filed: Nov. 25, 2015

Related U.S. Application Data
(60) Provisional application No. 62/085,313, filed on Nov. 27, 2014.

(51) Int. Cl. H04R 1/02

(52) U.S. Cl. CPC H04R 1/025; H04R 1/026; H04R 2201/021

(57) ABSTRACT

A system for housing an item in a structure. The system has an enclosure with a rear face which is coupled to a body which extends outward form the rear face and having an open face opposing the rear face. A hole is located in the body for connecting the housed item to an electrical system. The enclosure has at least one flange extending outward from the body for attaching the enclosure to a structure such as a wall. The enclosure has an attaching device used to couple to a faceplate. When mounted, the item and faceplate are visible but the enclosure is not.

### PRIORITY

This application claims priority to U.S. Provisional Application No. 62/085,313 filed Nov. 27, 2014, the entirety of which is hereby incorporated by reference.

### BACKGROUND OF THE INVENTION

1. Technical Field

The present invention relates generally to enclosures for electronic devices and more particularly, to a wireless speaker enclosure for mounting at least partially within the wall of a home, building or other structure.

2. Description of Related Art

Speakers are well-known components of audio/video and home entertainment systems. In typical systems, speakers are positioned at various locations around a room to provide for an optimal listening experience for users of the system. While in the past, speakers were connected to stereo receivers and other audio sources via wired connections, many speakers are now being produced that are configured to receive audio data via a wireless transmission signal in accordance with a wireless communication protocol (e.g., any wireless standard including IEEE 802.11a, 802.11b, 802.11g, 802.11n, or 802.15). To receive wireless signals, a wireless speaker must include one or more antennas to receive such signals. Further, such wireless speakers are typically powered via a wired electrical connection. The wires and/or cables typically employed to provide such wired connection are often unsightly, preventing users from achieving the “clean” look (no wiring/cables exposed) they desire in an audio/video or home entertainment system.

As a result, there is a need in the prior art to enclose such wireless speakers in a manner that will best provide an appearance free from exposed wiring/cables, and further reduce the amount of wireless signal attenuation that might be caused by such an enclosure. The systems, devices and methods taught herein meet these and other long-felt but unmet needs in the prior art.

### BRIEF DESCRIPTION OF THE SEVERAL VIEWS OF THE DRAWINGS

The novel features believed characteristic of the inventions are set forth in the appended claims. The inventions themselves, however, as well as preferred modes of use, further advantages thereof, will be best understood by reference to the following detailed description of illustrative embodiments when read in conjunction with the accompanying drawings, wherein:

FIG. 1 is a perspective view of a speaker mounted in a speaker enclosure in one embodiment;

FIG. 2 is a perspective view of an enclosure in one embodiment;

FIG. 3 is a front view of the faceplate of the enclosure in one embodiment;

FIG. 4 is a top view of the faceplate of the enclosure in one embodiment;

FIG. 5 depicts a view of the enclosure coupled to an electrical receptacle in one embodiment.

Where used in the various figures of the drawings, the same reference numerals designate the same or similar parts. All figures are drawn for ease of explanation of the basic teachings of the invention only; the extensions of the figures with respect to number, position, relationship, and dimensions of the parts to form the preferred embodiment will either be explained or will be within the skill of persons of ordinary skill in the art after the following teachings of the present invention have been read and understood.

### DETAILED DESCRIPTION OF THE DRAWINGS

Several embodiments of Applicant's invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein.

Systems and devices for enclosing wireless speakers and other electronic devices are disclosed herein. It should be noted that while the exemplary embodiments of enclosures discussed herein are taught in association with their application in the context of wireless speakers, the systems and devices taught herein could also be equally utilized in connection with other types of electronic devices that would benefit from the incorporation of the types of enclosure structures and mounting methods discussed herein.

Referring to FIG. 1, FIG. 1 is a perspective view of a speaker mounted in a enclosure in one embodiment. As depicted a speaker 109 is shown enclosed within an enclosure 100 such that the only portion visible, when mounted, is the face place 107. Accordingly, none of the portions or parts of the speaker enclosure 100, discussed in detail below, are visible when the speaker is installed in its mounted and recessed position. It should be noted that while a speaker is referenced in one embodiment, this is for illustrative purposes only and should not be deemed limiting. Virtually any item to be housed can be housed in the enclosure disclosed herein. Suitable items include lights, speakers, smoke detectors, consumer electronics, televisions, tablets, touch pads, key pads, interface modules, thermostats, input devices, displays, protectors, digital and non-digital signage display, emergency lights, sensors and equipment, visual indicators for emergency situations, audio devices, microphones, cameras or other visual recording equipment, and virtually any item which is mounted in a structure. A structure, as used herein, refers to any structure into which an enclosure can be mounted and recessed. A structure includes, but is not limited to, a wall, a ceiling, a floor, a stanchion, a kiosk, a column, or other free-standing structures, etc. Furthermore, while an embodiment describing a wireless speaker is described, this is for illustrative purposes only and should not be deemed limiting. In other embodiments, for example, a wired speaker is utilized. The speaker can be wired to receive power and signals.

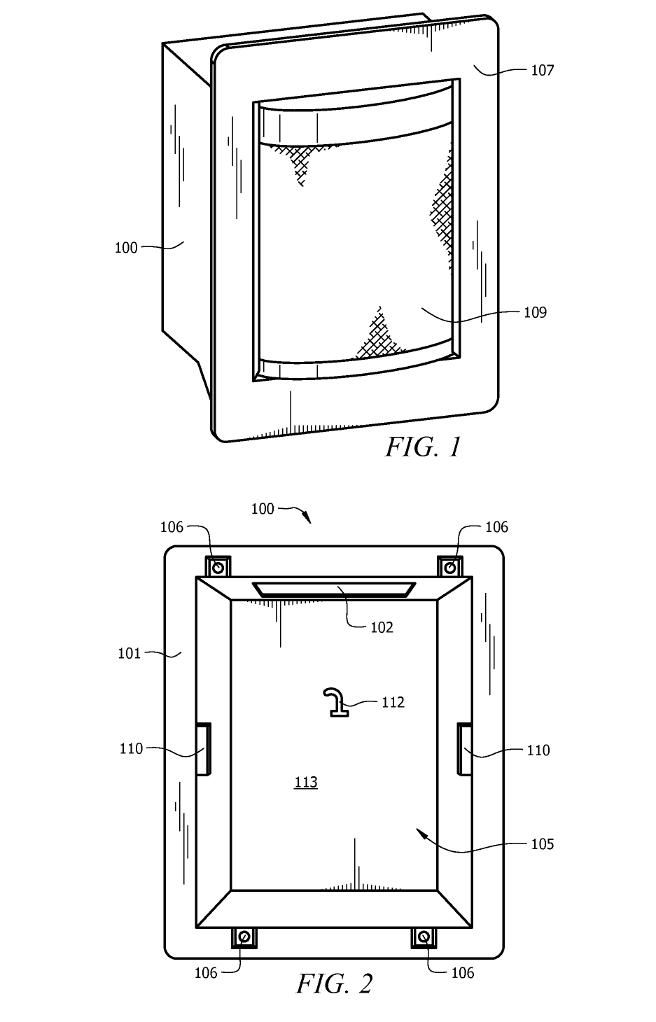

FIG. 2 is a perspective view of the enclosure in one embodiment. In one embodiment, the enclosure 100 generally takes the form of a rectangular box (or rectangular cuboid) having at least one open side for insertion of a speaker or other electronic device for enclosure and protection. The enclosure 100 can comprise virtually any cross-sectional shape including triangular, triangular, square, trapezoidal, rhombic, circular, oval, polygonal, etc. The enclosure 100 can be modified to surround and hold a speaker of virtually any shape or size. While an enclosure 100 with a rectangular cross-section will be described, this is for illustrative purposes only and should not be deemed limiting.

As noted, the enclosure 100 comprises at least one open side 105 through which the speaker can be inserted. The open side 105 can be located on any side of the enclosure 100, but as depicted, the open side 105 resides on the front face.

As depicted, the enclosure 100 comprises a rear face 113 coupled to a body which extends outward from the planar surface of the rear face 113. In one embodiment, and as depicted, the body comprises a plurality of sides which reside in a plane which are approximately perpendicular to the plane of the rear face 113. In one embodiment, the body comprises four sides which extend perpendicular from the rear face 113. As shown there is a top side, a left side, a right side, and a bottom side. In one embodiment the rear face 113 and the sides are integrally made from a single piece. In other embodiments they comprise two or more pieces coupled together.

A hole 102 is located on one side of the enclosure, allowing for the insertion of an electrical socket outlet or other items discussed in more detail below. In one embodiment, and as depicted, the hole 102 is located on the top side of the enclosure 100. The hole 102 can be placed on any side of the enclosure which allows the insertion of power or other electrical components and/or low voltage wires such as speaker wires, network wires, Ethernet cords, signal lines, conduits, etc. The outer ports of the electrical outlet can protrude through the hole 102 in the top side of the enclosure 100, allowing an installer of the enclosure 100 access to plug in a speaker power cable to the source of power such as an electrical outlet.

Materials used to construct the enclosure 100 may be chosen based upon several factors such as, for example, durability, ease of manufacture, cost, specific density, electrical conductivity, magnetic properties, and wireless attenuation properties. Materials chosen to construct the enclosure 100 may include metals and metal alloys, polymers, organic materials (for example, wood), masonry, composite, stone, fiber-based components, carbon fiber, fiber glass, and any other material suitable for usage as an enclosure for electronic devices. In one embodiment, a material having a low wireless attenuation properties, such as a plastic, will be selected to construct the enclosure as the usage of such materials will reduce the attenuation of wireless signals being transmitted to and received by a speaker housed within the enclosure.

Other factors to be considered when choosing the material(s) to be utilized to construct the enclosure should include the types of signals that will be received and/or transmitted to the electronic device intended to be enclosed within the enclosure. For example, other types of wireless signals may be utilized for transmission to/from the electronic device housed within embodiments of the enclosure such as, for example, WiFi signals, Z-Wave signals, Bluetooth signals, WiMAX signals, infrared signals, Near-Field Communications (NFC) signals, and ZigBee signals. Transmission properties of the foregoing types of signals will inform that selection of material(s) to be utilized for construction of the enclosure. Any type of wireless signal can be utilized with the enclosure disclosed herein.

While one embodiment of the enclosure is configured for insertion of a speaker receiving transmission of power through a wired connection, alternate embodiments of the enclosure may house speakers and other electronic devices powered wirelessly, such as wireless power or wireless energy transmission. In such alternate embodiments, the enclosure 100 may not require a hole 102 formed in a side of such enclosure. However, in such alternate embodiments configured to enclose an electronic device utilizing wireless energy transmission, many of the same types of factors as discussed above with respect to enclosures of traditionally powered electronic devices, will equally apply when selecting material(s) for construction of the enclosure. Depending on the type of wireless energy transmission utilized by the electronic device to be housed within the enclosure, the material(s) chosen to construct such enclosure should be selected to reduce interference with such energy transmission.

Returning back to FIG. 2, FIG. 2 illustrates laterally extending flanges 101 which are coupled on the edges of the open face 105 of the enclosure. The flanges 101 can be coupled to the edges of the enclosure 100 via a hinge, bolt, screw, welding, or the like. In other embodiments the flanges 101 are integrally made with the edges to which they are attached. In one of such embodiments, material is simply folded over to form the flanges 101. The flanges 101 provide a surface upon which the enclosure may be mounted to a wall or other structure, said enclosure configured to be at least partially enclosed by said wall or other structure. As discussed further below, a user mounting the enclosure within a wall may use fasteners to mount the enclosure to a wall, said fasteners being drilled into the side flanges 101 and further into the sheetrock or other wall material.

As depicted in FIG. 2 each edge of the open face has one flange 101. Accordingly, the top edge has a flange 101, the bottom edge has a flange 101, and each of the left and right edges of the open face 105 comprise a flange 101. This is for illustrative purposes only and should not be deemed limiting. In other embodiments the enclosure 100 can comprise less than one flange 101 per edge. As an example, if the enclosure 100 is to be mounted flush up against a ceiling, in certain embodiments the top edge of the open face 105 will not comprise a flange 101 as this allows the enclosure to be flush against the ceiling. In other embodiments the open face 105 will not comprise either a left, right, or bottom side. As depicted, all of the flanges 101 are interconnected as a single piece. This is for illustrative purposes and should not be deemed limiting. In other embodiments the flanges 101 are separated by a gap and are not connected as a single piece.

As depicted, at least one flange 101 has at least one coupling hole 106. The coupling holes allows the flange 101 to be coupled to a structure, such as a wall, via any attaching device known in the art. This includes fasteners, screws, bolts, nails, etc. In one embodiment, drywall screws with anchors are used to secure the enclosure 100 to a wall or other structure. One or more drywall screws may be driven into the side flanges 100 of the enclosure and into the drywall (sheetrock) or other structure into which the enclosure will be secured. ternate embodiments of the enclosure, other means of securing the enclosure to a wall or structure may be

Such means of securing the enclosure to a wall or other structure may include the usage of other types of fasteners (screws, nails, etc.), adhesives, welding, magnets, etc.

While one embodiment has been described utilizing a flange 101, this is for illustrative purposes only and should not be deemed limiting. As noted, in some embodiments the flange 101 is used secure the item into a structure. Those skilled in the art will understand there are other features and methods of securing an item into a recess of a structure. These can include, but are not limited to old work boxes, for example. These and other systems attach and couple to the structure from within the enclosure 100 as opposed to flanges 101. In one embodiment the coupling hole 106 further comprises a flip tab. Flip tabs, also referred to as tension tabs, tab clamps, corner tabs, and stabilizing clamps are tabs when press upon the opposing side of the wall, such as sheetrock, to help stabilize an item. As but one example, in one embodiment the flip tabs, when tightened, grip the opposing side of the sheetrock In one embodiment these tabs may be perpendicular to the wall initially, but upon tightening, flip to be parallel with the wall.

As depicted the front face 105 further comprises an attaching device 110. An attaching device 110 couples the enclosure 100 with the faceplate 107 depicted in FIG. 1 and discussed in more detail below. The attaching device 110 can comprise any method or device known in the art for coupling two objects to one another. For example, in one embodiment, the faceplate 107 is removably attached to the front of the main enclosure body with the use of “fugitive glue.” In other alternate embodiments, the faceplate 107 is removably attached to the enclosure with other materials such as fasteners, screws, bolts, nails, etc., magnets, and adhesives of various tacks. In still other embodiments, the faceplate 107 is attached via a friction fit. Those skilled in the art will understand the various methods and arrangements used in a friction fit pairing. These can include, but are not limited to, a ball-detent socket and a peg in a hole arrangement. In still other arrangements, the attachment occurs with a sliding arrangement. In one such example, the enclosure 100 will comprise slits through which the faceplate 107 can slide in from one or more sides. In further alternate embodiments of the enclosure, more permanent ways of securing the faceplate to the enclosure may be utilized. The more permanent ways can include welding, soldering, etc. As depicted, the attaching device 110 comprises two magnets which releasably adhere and couple to the faceplate 107. As depicted the attaching device 110 is coupled to two edges located on the front face 105. This ensures the attaching devices 110, magnets in this instance, to be located adjacent to the faceplate 107 when the faceplate 107 is installed.

Sitting on the rear face 113 of the enclosure 100 is an anchor point 112. An anchor point 112, as used herein, refers to a feature located on the enclosure 100 which allows an anchor line to couple the anchor point to the housed item, such as a speaker. In operation, an installer can couple the speaker, for example, to the anchor point 112 via an anchor line. Such an anchor line increases safety as it provides an additional method to ensure that the speaker, for example, does not fall out of the enclosure 100 and injure a person below or destroy the speaker or items below the speaker. The anchor point 112 can comprise any element upon which an anchor line can be attached. In one embodiment, and as depicted, the anchor point 112 comprises a feature cut, etched, or otherwise formed in one side of the enclosure 100. In one embodiment the anchor point 112 comprises a separate piece which snaps into or otherwise couples to a hole or attaching device in the enclosure 100. In one embodiment the anchor point 112 has the shape of an upside down “J” wherein the anchor can loop around the curve and secure to the anchor point 112. As depicted, the anchor point 112 is located on a rear face 113 but this is for illustrative purposes only and should not be deemed limiting. The anchor point 112 can be located on any face. In one embodiment the anchor point 112 allows the housed item, such as a speaker, to be anchored via an anchor line while the anchor line is not visible. Accordingly, safety is increased without compromising aesthetics. Additionally, the anchor point 112 and the associated anchor act as an anti-theft device preventing or making it more difficult to steal the item.

Virtually any dimensions can be utilized on the enclosure. The dimensions and shape will depend upon the object to be housed. Thus, if the object to be housed is rectangular, then the enclosure, in some embodiments, will have a complementary shape. Alternate embodiments of the enclosure may have other shapes and sizes, depending on the type, shape and size of the electronic device being enclosed. In one embodiment the enclosure 100 has a width of about 3 inches to about 12 inches. In one embodiment the enclosure 100 has a width of about 5.5 inches. In one embodiment the enclosure 100 has a depth of about 2 inches to about 6 inches. In one embodiment the enclosure 100 has a depth of about 3.5 inches. In one embodiment the enclosure 100 has a height of about 4 inches to about 12 inches. In one embodiment the enclosure 100 has a width of about 7 3/16 inches.

In one embodiment the hole 102 formed on the top side of the enclosure 100 as shown in FIG. 2 has rectangular dimensions of 3 11/16 inches by 2¼ inches. However, these dimensions are for illustrative purposes only and should not be deemed limiting. Those of skill in the art will appreciate that the size of the enclosure hole 102 may vary depending on the size, shape and type of electrical components utilized to power the speaker or other electronic device enclosed by the enclosure.

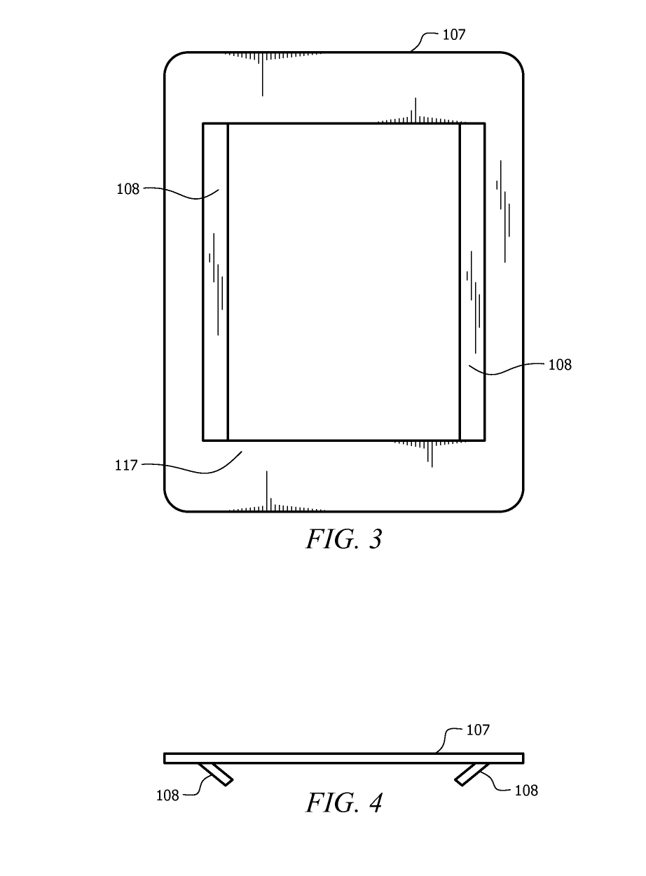

Referring now to FIG. 3, FIG. 3 is a front view of the faceplate of the speaker enclosure in one embodiment. The design of the faceplate 107 serves both a decorative purpose and a utilitarian purpose. While the faceplate 107 gives the enclosure and speaker a more finished and seamless look, support element 108 formed on the rearward side edges of the faceplate serve to secure a speaker or electronic device within the enclosure, preventing the accidental falling of the speaker/electronic device. The support element 108 can be straight or angled, as depicted. As noted, the support element 108 offers support to the speaker or other electronic device and secures the device in place.

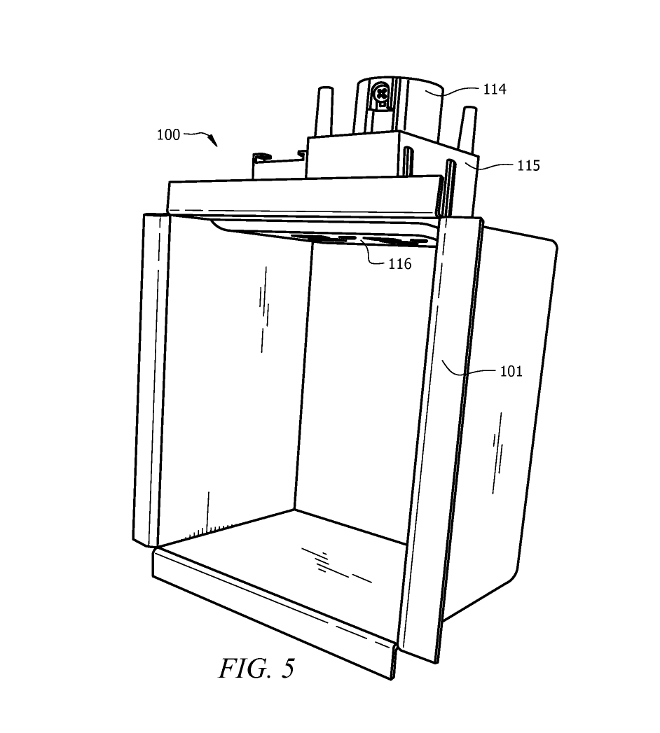

FIG. 4 is a top view of the faceplate of the speaker enclosure in one embodiment. As depicted, the support element 108 protrude into an aperture cut formed in the middle of the faceplate. When the faceplate 107 is mounted on the box of the enclosure 100, the aperture allows the inside of the enclosure to be seen when mounted within a wall. Thus, when a speaker, for example, is mounted within the enclosure 100, the aperture formed into the faceplate 107 permits the front face of a speaker to be seen. The faceplate 107 of the enclosure 100 can be constructed of any number of materials and ideally, of materials having reduced wireless attenuation properties as discussed above with respect to the main enclosure body. The faceplate 107 can be removably attached to the front side of the main enclosure body 100 by various means and devices as discussed above.

Alternate embodiments of the faceplate of the enclosure may have other shapes and sizes, depending on the type and size of the electronic device being enclosed in the enclosure. In one embodiment the aperture formed on the top front side of the faceplate 107 has rectangular dimensions of 5¼ inches by 6 1/16 inches. However, these dimensions are for illustrative purposes only and should not be limiting. Those of skill in the art will appreciate that the dimensions and shape of the aperture may vary depending on the size, shape and type of speaker or other electronic device enclosed by the enclosure. Likewise, while the angle of the angled flange extends from the faceplate at an angle of about sixty degrees with respect to the back surface of the main faceplate structure, alternative embodiments of the faceplate may include angled flanges extending at other angles, depending on the size and shape of the speaker, or other electronic device, to be mounted within the enclosure.

Now turning to FIG. 5, FIG. 5 depicts a view of the enclosure coupled to an electrical receptacle in one embodiment. In many states it is a code violation to have power cords in the wall without having a place where the cords can disconnect. Accordingly, in one embodiment an electrical receptacle 115 is inserted into the hole 102. As can be seen, the electrical receptacle 115, as depicted, comprises an electrical outlet 116 which is accessible from the inside of the enclosure 100. Accordingly, the electrical cord of the speaker, for example, can simply be plugged into the electrical outlet 116. In one embodiment, any slack in the speaker's cord is collected and stored so as to not be visible when the faceplate 107 is installed, In one embodiment the enclosure 100 comprises a hook, strap, or other element upon which excess cordage can be secured. In another embodiment, the cord may be secured by an external separate piece which snaps or otherwise couples to a hole or feature in the enclosure 100. In still other embodiments the enclosure comprises a cavity into which excess cordage can be inserted. In still other embodiments the enclosure 100 comprises a compartment or box which houses the wound excess cordage. The box can be inside or outside of the enclosure 100.

As depicted, the electrical receptacle 115 comprises an electrical inlet 114 which can be hardwired or otherwise coupled to the structure's electrical system. An installer or other electrician can wire the electrical receptacle 115 which will power the speaker when the speaker is plugged into the outlet 116.

The electrical receptacle 115 can be packaged with the enclosure 100 or the receptacle 115 can be purchased separately. Utilizing an electrical receptacle 115 provides the ability to plug-in and remove the speaker as desired. Further, this provides the ability to install a recessed speaker while not violating housing codes, depending upon the state.

In the embodiment depicted, the electrical receptacle 115 is shown with the outer cover removed. Accordingly, the inner components of the electrical receptacle 115 are visible. In other embodiments, however, the electrical receptacle 115 will further comprise an outer cover which houses the depicted components.

While one embodiment has been described utilizing an electrical receptacle 115, this is for illustrative purposes only and should not be deemed limiting. Such an embodiment is installer friendly and requires minimal assistance from an electrician. In other embodiments, however, a home-owner, for example, may desire to install the enclosure 100 themselves. A home-owner can utilize many work arounds currently available on the market. In one embodiment the home-owner can utilize a power relocation kit. A power relocation kit is a kit which allows a user to relocate power, or electrical outlets, behind an object or in a wall. Such kits are often used for flat panel television sets which are mounted on the wall. Many of these kits are pre-wired and do not require any electrical wiring by the user. Accordingly, a user can utilize a power relocation kit to provide power to the housed item. In such embodiments the speaker wire would either extend through the hole 102, or the kit's power outlet 116 would couple to the enclosure 100 similar to the electrical receptacle 115 depicted in FIG. 5.

In other embodiments a commercially friendly enclosure 100 and electrical connector can be utilized. In some states, commercially installed equipment will require that the enclosure 100 comprise a specific material such as metal. Those skilled in the art will understand the various changes in material, arrangement, etc. required to comply with the various codes for commercially installed equipment.

Many audio/video and home entertainment systems utilize wireless signals to transmit audio data to speakers and other electronic devices configured to receive such wireless signals for playback. Prior to mounting the enclosure 100 within a structure, such as a wall, a hole sized to receive the enclosure 100 must be cut into the structure. Although not limiting, a wall will be described for illustrative purposes. An installer of the enclosure 100 must take steps to ensure that an electrical line is adjacent to the location where the enclosure will be positioned so that an electrical connection can be made to the speaker or other electronic device intended to be mounted within the enclosure 100. As noted, this can be accomplished via the various methods and devices discussed above including, but not limited to, an electrical receptacle to which the speaker electrically couples, a power relocation kit, etc. Once a hole is cut into the wall, the enclosure is inserted into the hole. Using drywall screws with anchors, or other securement devices known in the art, the enclosure 100 is coupled to the wall via at least one of the enclosure's flanges 101.

Next, the installer electrically powers the enclosure 100. In one embodiment this step comprises electrically coupling the electrical receptacle 115 to the source of power. As noted, in one embodiment the electrical outlet 116 is mounted to the top of the enclosure 100 by passing through the hole 102 at the top of the enclosure 100.

Thereafter, the speaker or other electronic device should be inserted into the enclosure 100 and connected to the electrical line. In one embodiment, the speaker is connected to the electrical power via the electrical outlet 116 coupled to the electrical receptacle 115. It should be noted that while this step is discussed after electrically powering the enclosure 100, this is for illustrative purposes only and should not be deemed limiting. In other embodiments, for example, the speaker is inserted prior to electrically powering the enclosure 100. The speaker can be inserted into the enclosure 100 at virtually any point in the installation process. The most efficient timing of inserting the speaker into the enclosure 100 will depend in part upon the structure in which it is installed, the electrical arrangement, etc.

Once the speaker or other electronic device is mounted within the enclosure 100 and connected to the electrical line, the faceplate 107 of the enclosure is mounted to the front of the enclosure 100 with any method or device discussed herein including magnets, low-tack adhesive such as fugitive glue, etc. The speaker or other electronic device may then be powered-on and otherwise configured to operate in conjunction with an audio/video or home entertainment device or other device for transmitting wireless signals such as, for example, a smart phone, desktop or, laptop computer, video game console, television, radio, etc.

Returning back to FIG. 1, now that the system and method has been discussed, the many benefits of the enclosure will be readily apparent. As noted, in one embodiment the enclosure 100 is installed recessed within a structure. In one embodiment the flanges 101 are in substantially the same plane as the structure to which they are attached. Specifically, in one embodiment the flanges 101 rest upon the outer surface of the structure. Accordingly, everything behind the flanges 101 is installed within and behind the structure. This allows the enclosure 100 and its various components to be hidden within the structure. This provides for a more aesthetically pleasing design. The electrical components, including any power cords or electrical outlets are hidden from view, and instead a clean and smooth faceplate 107 and speaker 109 are the only items visible.

Second, in one embodiment, as discussed and shown in FIG. 1, at least a portion of the face of the speaker 109 is visible when installed. In one embodiment, the entire front face of the speaker 109 is visible when installed. This is a benefit because more and more items to be housed, such as speakers, are designed to be aesthetically pleasing. Many consumers of these speakers 109, for example, desire that the speaker 109 is visible. Often these consumers pay a premium for their specific speakers 109, and desire that the aesthetics, brand, etc. of the speaker 109 not be hidden by the speaker mount. The system discussed herein provides the opportunity to fully display the front face of the speaker 109.

While one embodiment has been described wherein at least a portion of the face of the item or speaker 109 is visible when installed, in other embodiments the item or speaker's face is not visible. This can be accomplished by having a separate screen attach to the faceplate 107. This separate screen can be a speaker mesh or other opaque item. Further, in one embodiment the faceplate 107 comprises a mesh or opaque surface.

Additionally, in some embodiments, because of the removable faceplate 107, it is easy for a consumer to adjust, remove, repair, and otherwise reach into the internal side of the enclosure with minimal effort. Further, because of the hole 102, attaching device for coupling the faceplate 107, flanges, anchor point, and/or the electrical receptacle, installation of the enclosure 100 within a wall is simple and quick. The flush and professional appearance, however, suggests a much more tedious and expensive installation. The installation works for retrofit installation as well as new construction installation.

An additional benefit is increased safety. First, an item is often inherently safer being mounted in a wall rather than being free-standing on a shelf. Furthermore, the speaker 109, or other housed item, in some embodiments, is secured by a plurality of methods and devices. As noted, in some embodiments the faceplate 107 comprises support elements 108 (shown in FIGS. 3 and 4) which extend from the faceplate 107 and which can engage the speaker 109. These support elements 108 help prevent the speaker 109 from falling out from the enclosure 100 and injuring people or property located beneath or adjacent to the speaker 109. Additionally, in some embodiment the enclosure 100 comprises an anchor point 112 which further secures the speaker 109 within the enclosure 100. If, for example, and earthquake provides sufficient force to jostle the speaker 109 out of the housing overcoming the support from the support elements 108, then the anchor line attached to the speaker 109 will prevent the speaker 109 from falling beyond the length of the anchor line. Accordingly, the anchor line provides another safety feature.

As noted and depicted, in one embodiment the front face of the speaker 109 extends outward beyond the plane of the structure and/or the enclosure 100. As depicted the speaker 109 comprises a curved front face, and accordingly, the curved face of the speaker 109 extends outward beyond the plane of the faceplate 107 and/or the structure.

The color, design, finish, and materials of the faceplate 107 can be adjusted as desired. For example, if a white speaker 109 is housed in the enclosure 100, then a corresponding white faceplate 107 can be utilized. If the white speaker 109 is thereafter replaced with a black speaker 109, then the faceplate 107 can be replaced with a black faceplate 107. This is beneficial because the remainder of the enclosure 100 need not be changed as it is not visible. Taken further, if the room in which the speaker 109 is to be installed has chrome features, such as chrome vents, door handles, etc., the faceplate 107 can comprise matching chrome.

As depicted and described herein, the enclosure 100 has been installed in a vertical position. Put differently, the speaker 109 is installed in a vertical wall. However, this is for illustrative purposes only and should not be deemed limiting. In other embodiments the enclosure 100 is installed in a horizontal position such as within a ceiling or floor. In still other embodiments the enclosure 100 is installed in an inclined position. In one of such embodiments the enclosure 100 is held in place via the support elements discussed herein. In other embodiments the enclosure 100 comprises additional support elements which help secure the housed item. These can include, for example, support elements attached to the enclosure 100. As an example, support elements can fold or retract to allow for insertion of the speaker 109 but beet then expand once the speaker 109 is installed. In other embodiments the enclosure 100 will comprise a harness which further attaches the speaker 109 to the enclosure 100. In still other embodiments a coupler such as screws, bolts, etc. mechanically couple the speaker 109 to the enclosure 100. In one embodiment the system further comprises a ceiling mount conversion bracket which couples or attaches to the item. As an example, speakers often have a female threaded receiver in the back of the speaker which can be coupled to the ceiling mount conversion bracket to snap the speaker into the desired location.

It should be noted that the description of the present invention has been presented for purposes of illustration and description, and is not intended to be exhaustive or limited to the invention in the form disclosed. Many modifications and variations will be apparent to those of ordinary skill in the art. The preferred embodiment appearing in the drawings was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims. Moreover, it should be noted that uses of the phrase “the present invention” within this disclosure are not intended to limit or otherwise restrict the scope of the invention(s) disclosed and claimed by the inventor, but said phrase is merely intended to refer to certain examples of embodiments of the invention(s).

### ADDITIONAL DESCRIPTION

The following clauses are offered as further description of the disclosed invention.

Clause 1. A system for housing an item in a structure, said system comprising:
an enclosure having a rear face, wherein said rear face is coupled to a body extending outward from said rear face, wherein said body comprises an open face;
a hole located in said body;
at least one attaching device for coupling to a faceplate, wherein said faceplate mates with said enclosure such that said enclosure is not visible when the faceplate is coupled to the enclosure.

Clause 2. The system of any proceeding or preceding clause further comprising at least one flange extending laterally from said body, wherein said faceplate mates with said at least one flange such that said at least one flange is not visible when the face place is coupled to the enclosure.

Clause 3. The system of any proceeding or preceding clause wherein said item comprises a speaker and wherein said structure comprises a wall.

Clause 4. The system of any proceeding or preceding clause wherein said enclosure is recessed mounted in said wall, and wherein said at least one flange is flush with said wall.

Clause 5. The system of any proceeding or preceding clause wherein at least one electrical receptacle is inserted through said hole located in said body, and wherein said enclosure and said electrical receptacle is not visible when mounted, and wherein said faceplate and said speaker are visible when mounted.

Clause 6. The system of any proceeding or preceding clause wherein said enclosure further comprises an anchor point for attaching an anchor line to said housed item.

Clause 7. The system of any proceeding or preceding clause wherein said faceplate comprises support elements extending from the planar face of said faceplate.

Clause 8. The system of any proceeding or preceding clause wherein said attaching device comprises at least one magnet.

Clause 9. The system of any proceeding or preceding clause wherein said at least one flange comprises at least one coupling hole for securing said enclosure to said structure.

Clause 10. The system of any proceeding or preceding clause wherein said enclosure comprises a substantially rectangular shape.

Clause 11. A system for housing a speaker in a wall, said system comprising:
an enclosure having a rear face, wherein said rear face is coupled to a top side, a left side, a right side, and a bottom side, wherein said top, bottom, left, and right side extend outward and perpendicular from said rear face;
a hole located in one of said sides allowing entry from outside of said enclosure into said enclosure;
an anchor point located on said rear face for attaching an anchor line to said speaker;
at least one flange extending from at least one of said sides, wherein said flange extends in a plane parallel to said rear face;
at least one attaching device for coupling to a faceplate, wherein said faceplate mates with said at least one flange such that said at least one flange is not visible when the faceplate is coupled to the enclosure.

Clause 12. The system of any proceeding or preceding clause wherein said at least one flange extends in a plane approximately perpendicular to at least one of said sides.

Clause 13. The system of any proceeding or preceding clause further comprising an electrical receptacle coupling to said enclosure through said hole.

Clause 14. The system of any proceeding or preceding clause wherein said electrical receptacle comprises an electrical outlet into which the speaker can plug its power cord.

Clause 15. A method of installing a recessed speaker in a housing, said housing comprising:
an enclosure having a rear face, wherein said rear face is coupled to a body extending outward from said rear face, wherein said body comprises an open face;
a hole located in said body;
at least one flange extending laterally from said body;
at least one attaching device for coupling to a faceplate, wherein said faceplate mates with said at least one flange such that said at least one flange is not visible when the faceplate is coupled to the enclosure; said method comprising:
cutting a hole in a wall;
inserting said enclosure into said hole;
coupling said enclosure to said wall via said at least one flange;
inserting a speaker into said enclosure;
connecting said speaker to at least one wire inserted through said hole;
coupling said faceplate to said enclosure, wherein said coupling results in said at least one flange not being visible but allowing said speaker to be visible.

Clause 16. The method of any proceeding or preceding clause further comprising the step of attaching an anchor line from said speaker to an anchor point located on said enclosure, wherein said anchor line is not visible.

What is claimed is:

1. A system for housing an item in a structure, said system comprising:
an enclosure having a rear face, wherein said rear face is coupled to a body extending outward from said rear face, wherein said body comprises an open face;
a hole located in said body;
at least one attaching device for coupling to a faceplate, wherein said faceplate mates with said enclosure such that said enclosure is not visible when the faceplate is coupled to the enclosure.

2. The system of claim 1 further comprising at least one flange extending laterally from said body, wherein said faceplate mates with said at least one flange such that said at least one flange is not visible when the face place is coupled to the enclosure.

3. The system of claim 2 wherein said item comprises a speaker and wherein said structure comprises a wall.

4. The system of claim 3 wherein said enclosure is recessed mounted in said wall, and wherein said at least one flange is flush with said wall.

5. The system of claim 4 wherein at least one electrical receptacle is inserted through said hole located in said body, and wherein said enclosure and said electrical receptacle is not visible when mounted, and wherein said faceplate and said speaker are visible when mounted.

6. The system of claim 2 wherein said enclosure further comprises an anchor point for attaching an anchor line to said housed item.

7. The system of claim 2 wherein said faceplate comprises support elements extending from the planar face of said faceplate.

8. The system of claim 2 wherein said attaching device comprises at least one magnet.

9. The system of claim 2 wherein said at least one flange comprises at least one coupling hole for securing said enclosure to said structure.

10. The system of claim 2 wherein said enclosure comprises a substantially rectangular shape.

11. A system for housing a speaker in a wall, said system comprising:
an enclosure having a rear face, wherein said rear face is coupled to a top side, a left side, a right side, and a bottom side, wherein said top, bottom, left, and right side extend outward and perpendicular from said rear face;
a hole located in one of said sides allowing entry from outside of said enclosure into said enclosure;
an anchor point located on said rear face for attaching an anchor line to said speaker;
at least one flange extending from at least one of said sides, wherein said flange extends in a plane parallel to said rear face;
at least one attaching device for coupling to a faceplate, wherein said faceplate mates with said at least one flange such that said at least one flange is not visible when the faceplate is coupled to the enclosure.

12. The system of claim 11 wherein said at least one flange extends in a plane approximately perpendicular to at least one of said sides.

13. The system of claim 11 further comprising an electrical receptacle coupling to said enclosure through said hole.

14. The system of claim 13 wherein said electrical receptacle comprises an electrical outlet into which the speaker can plug its power cord.

15. A method of installing a recessed speaker in a housing, said housing comprising:
an enclosure having a rear face, wherein said rear face is coupled to a body extending outward from said rear face, wherein said body comprises an open face;
a hole located in said body;
at least one flange extending laterally from said body;
at least one attaching device for coupling to a faceplate, wherein said faceplate mates with said at least one flange such that said at least one flange is not visible when the faceplate is coupled to the enclosure; said method comprising:
cutting a hole in a wall;
inserting said enclosure into said hole;
coupling said enclosure to said wall via said at least one flange;
inserting a speaker into said enclosure;
connecting said speaker to at least one wire inserted through said hole;
coupling said faceplate to said enclosure, wherein said coupling results in said at least one flange not being visible but allowing said speaker to be visible.

16. The method of claim 15 further comprising the step of attaching an anchor line from said speaker to an anchor point located on said enclosure, wherein said anchor line is not visible.
